(19) United States
(12) Patent Application Publication
(10) Pub. No.: US 2006/0191967 A1
(43) Pub. Date: Aug. 31, 2006

(54) Clamp assembly for securing a ladder to a vehicle rack

(75) Inventors: Robert F. Smith, Pageland, SC (US); Michael S. Richardson, Waxhaw, NC (US)

Correspondence Address: Schwartz Law Firm, P.C.;SouthPark Towers, Suite 1135, 6100 Fairview Road, Charlotte, NC, 28210, US

(73) Assignee: Nordman Corporation of NC

(21) Appl. No.: 11/397,653

(22) Filed: Apr. 4, 2006

Related U.S. Application Data
(63) Continuation-in-part of application No. 10/706,558, filed on Nov. 11, 2003.

(51) Int. Cl. B60R 9/00

(52) U.S. Cl. 224/319

(57) ABSTRACT

A clamp assembly operates to hold first and second articles together. The clamp assembly includes an article holder adapted for engaging the first article, and an attached flexible cable. The cable has a proximal end fixed to the article holder and a free end depending from the article holder. A first fastener is located on the cable between its proximal and free ends. A second fastener is located at the free end of the cable. A cable retracting wheel operates to retract the cable relative to the article holder.

### TECHNICAL FIELD AND BACKGROUND OF THE INVENTION

This invention relates generally to a clamp assembly, and more specifically to a clamp assembly designed and adapted for securing a ladder or other loose article to a vehicle rack. The invention is quickly and conveniently applied, and offers increased safely and security over existing methods and devices for temporarily mounting ladders on vehicle racks. The invention is especially applicable for use by commercial contractors, such as painters, roofers, and window washers.

For many commercial contractors, ladders are essential implements which must be loaded on a vehicle and transported between multiple job sites during the day. The contractor's vehicle typically includes an overhead or side-mounted ladder rack or canopy rack designed for carrying one or more ladders. Time and convenience are generally the primary concerns when securing the ladder to the vehicle rack. Some contractors use a combination of bungee cords, nylon straps, cables, and/or chains to tie the ladders directly to the rack. While these items are relatively inexpensive and often readily available, they are frequently applied in haste and with little attention paid to the working condition of the straps and cords. The result is that many ladders are transported on busy roads and highways in a generally unsafe condition. In addition, these items provide little if any protection against theft.

### SUMMARY OF INVENTION

Therefore, it is an object of the invention to provide a clamp assembly which is especially applicable safely and conveniently securing one or more ladders to a vehicle rack.

It is another object of the invention to provide a clamp assembly which is applicable for securing multiple stacked ladders to a vehicle rack.

It is another object of the invention to provide a clamp assembly which is applicable to all types of ladders including extension and step ladders.

It is another object of the invention to provide a clamp assembly which is adjustable for attachment to all types of vehicle racks.

It is another object of the invention to provide a clamp assembly which protects against theft.

It is another object of the invention to provide a clamp assembly which can be quickly applied and removed in only a few seconds.

It is another object of the invention to provide a clamp assembly which is compact for convenient storage when not in use.

It is another object of the invention to provide a clamp assembly which is lightweight and durable.

It is another object of the invention to provide a clamp assembly which offers increased holding strength to secure one or more ladders to the vehicle in the event of a sudden stop or accident.

It is another object of the invention to provide a clamp assembly which substantially eliminates any sideways shifting of the ladders during transport.

It is another object of the invention to provide a clamp assembly which has no protruding parts.

It is another object of the invention to provide a clamp assembly which has only a few component parts.

It is another object of the invention to provide a clamp assembly which is relatively inexpensive to manufacture.

It is another object of the invention to provide a clamp assembly which can be used for articles other than ladders.

It is another object of the invention to provide an improved method for securing one or more ladders to a vehicle rack.

These and other objects of the present invention are achieved in the preferred embodiments disclosed below by providing a clamp assembly for holding first and second articles together. The clamp assembly includes an article holder adapted for engaging the first article, and an attached flexible cable. The cable has a proximal end fixed to the article holder and a free end depending from the article holder. A first fastener is located on the cable between its proximal and free ends. A second fastener is located at the free end of the cable. Cable retracting means operates to retract the cable relative to the article holder. Preferably, the first and second articles are held together by wrapping the cable around the second article, attaching the second fastener to the first fastener, and then retracting the cable.

According to another preferred embodiment of the invention, a gear housing is formed with the article holder.

According to another preferred embodiment of the invention, the cable retracting means includes a toothed gear wheel contained within the gear housing, and having a plurality of circumferentially-spaced gear teeth.

According to another preferred embodiment of the invention, a gear lock is adapted for engaging the gear teeth of the gear wheel to hold the gear wheel in a locked condition.

According to another preferred embodiment of the invention, the gear lock includes a plurality of locking teeth adapted for meshing with the gear teeth of the gear wheel in the locked condition.

According to another preferred embodiment of the invention, biasing means operates to normally urge the gear lock into the locked condition.

Preferably, the biasing means includes at least one spring.

According to another preferred embodiment of the invention, a release arm is formed with the gear lock. The release arm is adapted for being manually moved against the biasing force of the spring to release the gear lock from the locked condition, such that the cable is extendable from the article holder.

According to another preferred embodiment of the invention, an annular, cable-collection shoulder is located adjacent the toothed gear wheel, and is adapted for storing cable retracted within the gear housing.

According to another preferred embodiment of the invention, the toothed gear wheel includes an annular, reduced-diameter spacer located adjacent the cable-collection shoulder.

According to another preferred embodiment of the invention, a toothed cavity is formed with the spacer, and is adapted for receiving the proximal end of the cable to secure the cable to the article holder.

Preferably, a hand knob is provided for rotating the toothed gear wheel.

According to another preferred embodiment of the invention, the article holder comprises a generally U-shaped channel.

Preferably, the article holder has a length dimension greater than two times its width dimension.

According to another preferred embodiment of the invention, the first fastener comprises a solid metal ball carried on the cable.

According to another preferred embodiment of the invention, the second fastener comprises a rigid metal claw adapted for releasably engaging the ball.

In another embodiment, the invention comprises an improved clamping system for holding first and second articles together. The clamping system incorporates a first clamp assembly and a second clamp assembly. The first clamp assembly comprises an article holder adapted for engaging the first article, a flexible cable having a proximal end fixed to the article holder, and a free end depending from the article holder, a fastener located at the free end of the cable, and means for retracting the cable relative to the article holder. A second clamp assembly is spaced-apart from the first clamp assembly, and includes an article holder adapted for engaging the second article. The second clamp assembly has a complementary fastener for attaching to the fastener of the first clamp assembly. The first and second clamp assemblies cooperate upon retraction of the cable to hold the first and second articles together.

According to another preferred embodiment of the invention, the cable retracting means includes a cable-retraction wheel.

Preferably, a hand knob is provided for rotating the cable-retraction wheel to retract the cable relative to the article holder of the first clamp assembly.

Preferably, each of the article holders comprise generally U-shaped channels each having a length dimension greater than two times its width dimension.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is an environmental view of a clamp assembly according to one preferred embodiment of the present invention, and showing the clamp assembly in-use securing two ladders together in a stacked condition;

FIG. 2 is a perspective view of the clamp assembly with the flexible cable extended from the gear housing;

FIG. 3 is a fragmentary view of the cable showing the claw fastener attached to the floating ball fastener;

FIG. 4 is an exploded view of the clamp assembly;

FIGS. 5 and 6 are perspective views of two clamp assemblies according to the present invention, and used in combination for securing multiple ladders together; and

FIGS. 7 and 8 are perspective views of three clamp assemblies according to the present invention, and used in combination for securing multiple ladders together.

### DESCRIPTION OF THE PREFERRED EMBODIMENT AND BEST MODE

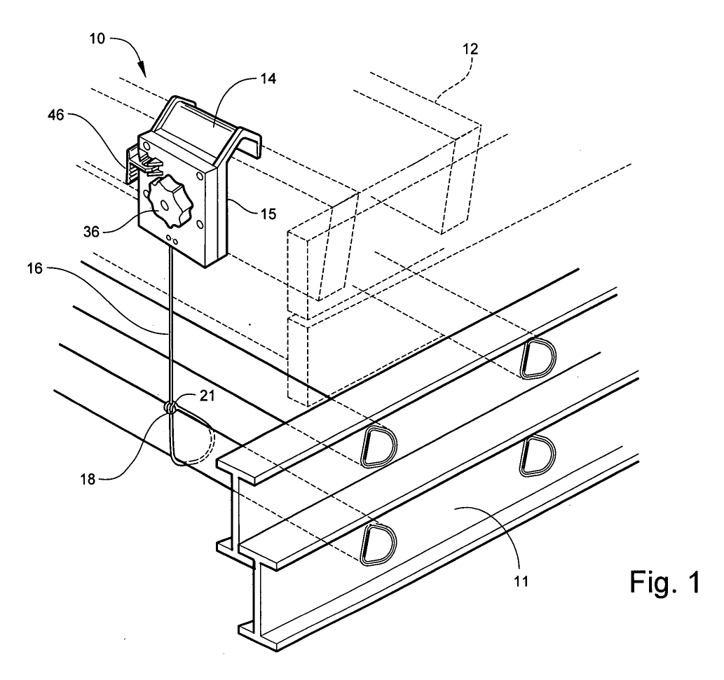

Referring now specifically to the drawings, a clamp assembly according to the present invention is illustrated in FIG. 1, and shown generally at reference numeral 10. In one application, the clamp assembly 10 operates to secure and lock one ladder 11 to another ladder 12 in a stacked arrangement, as shown. The ladders 11, 12 may be of any standard size and design including step ladders, extension ladders, combination ladders, and the like. Alternatively, the clamp assembly 10 may be used to secure one or more such ladders directly to a vehicle rack or other cargo carrier (not shown). The clamp assembly 10 may also be used in other applications, and for a wide variety of articles other than ladders.

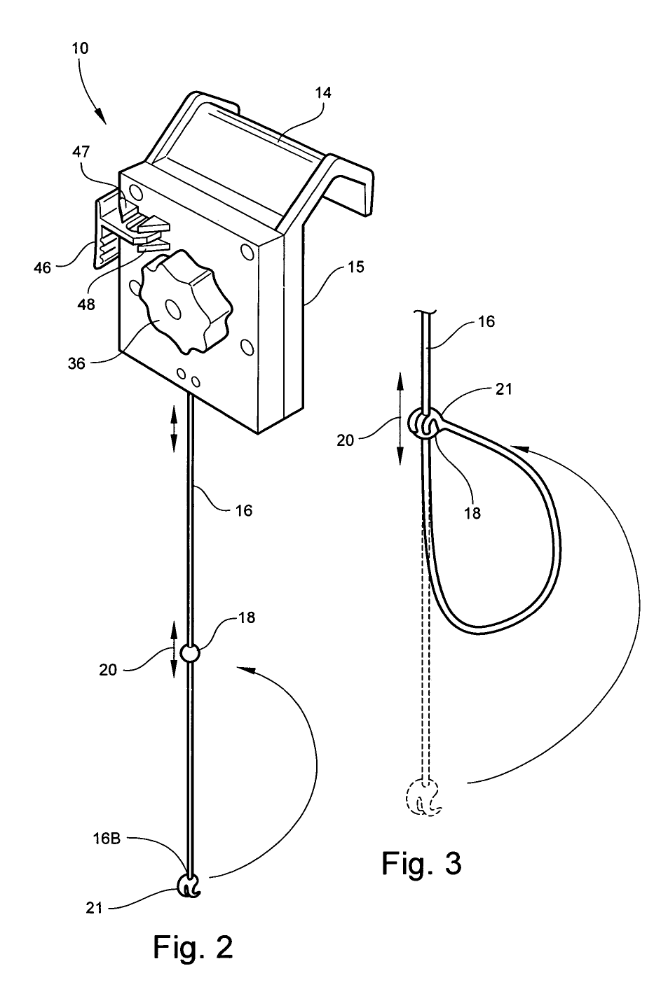

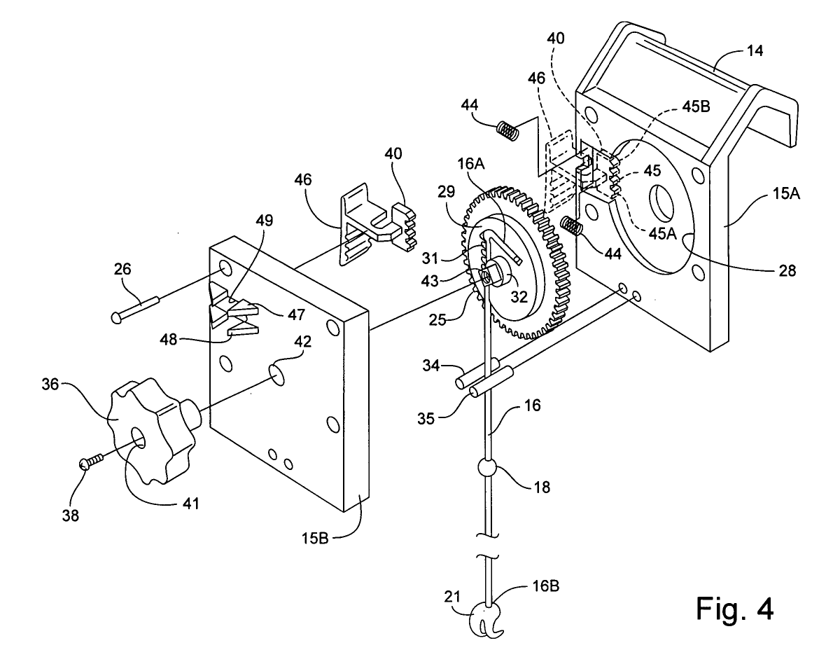

As shown in FIGS. 1, 2, and 3, the clamp assembly 10 includes a generally U-shaped rigid holder 14 designed to engage a portion (e.g., rung) of the ladder 12, a gear housing 15 formed with the holder 14, and an elongated flexible wire cable 16. A floating solid-metal ball fastener 18 is carried on the cable 16 and designed to slide between proximal and free ends 16A, 16B of the cable 16, as indicated at arrow 20 in FIG. 2. A second, claw-type fastener 21 is located at the free end 16B of the cable 16. After placing the holder 14 on the top ladder 12, as shown in FIG. 1, the free end 16B of the cable 16 is wrapped around a portion (e.g., rung) of the underlying second ladder 11. The claw fastener 21 is then applied to the floating ball fastener 18, as demonstrated in FIG. 3. Finally, the cable 16 is retracted within the gear housing 15, as described below, causing the looped free end 16B to wrap tightly around the second ladder 11, and pulling the first and second ladders together.

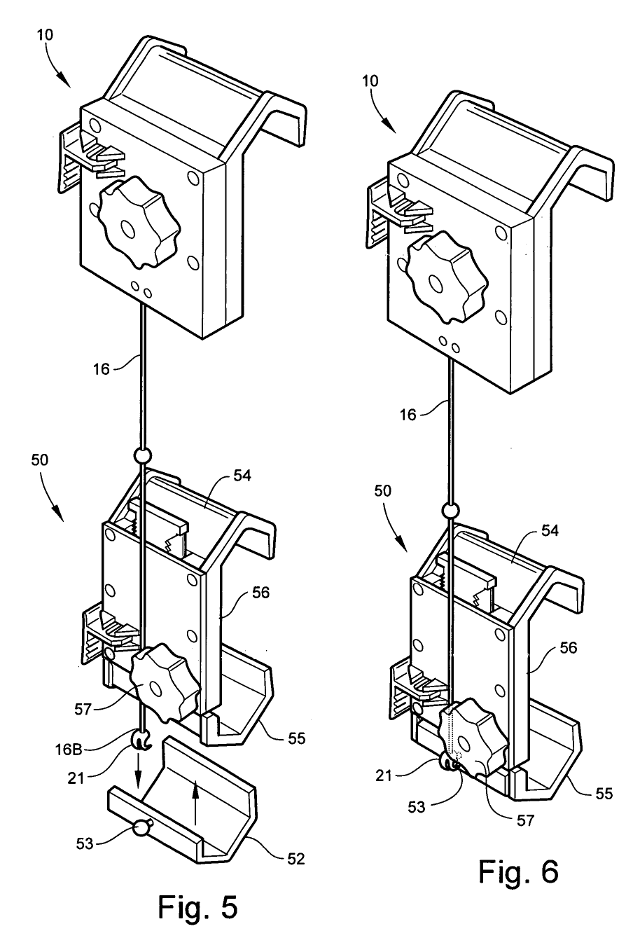

The internal components of the gear housing 15 and cable retracting means are best illustrated in the exploded view of FIG. 4. The gear housing 15 comprises a first half 15A integrally formed with the holder 14, and a second half 15B which cooperates with the first 15A to encase a toothed gear wheel 25. The first and second halves 15A, 15B are joined together using any suitable means including rivets 26 (only one shown), or screws, adhesive, welding, and the like. The gear wheel 25 resides substantially within an annular recess 28 formed with the first half 15A, and has an integral annular spacer 29 with a generally L- or V-shaped toothed cavity 31 designed to receive and secure the proximal end 16A of the flexible cable 16. A smaller diameter cable-collection shoulder 32 is formed with the spacer 29, and operates to collect and store the flexible cable 16 inside the housing 15 when the cable 16 is retracted. Preferably, spaced guide pins 34, 35 extend between the first and second halves 15A, 15B of the housing 15, and cooperate to guide extension and retraction of the cable 16.

The gear wheel 25 is rotated to retract the cable 16 using a convenient hand knob 36. The hand knob 36 is connected to the gear wheel 25 by a threaded pin 38 received through aligned openings 41, 42 in the knob and housing half, and into a complementary-threaded opening 43 formed adjacent the cable-collection shoulder 32. By manually rotating the hand knob 36 in a clockwise direction, the gear wheel 25 turns causing the cable 16 to wind around the cable-collection shoulder 32 and retract inside the housing 15. Once retracted to a desired length, a toothed gear lock 40 operates to hold the gear wheel 25 fixed, thus preventing extension (or backlash) of the cable 16 from the housing 15. Compression springs 44 normally urge the teeth 45 of the gear lock 40 into meshing alignment with the gear teeth of the gear wheel 25. In this meshed condition, the leading end tooth 45A of the gear lock 40 is formed to enable continued clockwise rotation of the gear wheel 25, while the trailing end tooth 45B prevents its counterclockwise rotation.

In order to release the gear lock 40, an attached release arm 46 is manually moved outwardly against the biasing force of the springs 41, 42 to disengage the meshing teeth of the gear lock 40 and gearwheel 25. In this condition, the gearwheel 25 can rotate freely in a counterclockwise direction thereby allowing extension of the cable 16 from inside the housing 15. Raised guards 47 and 48 are preferably formed with the housing 15 adjacent a release-arm slot 49 to protect the release arm 45 against damage during use of the clamp assembly 10.

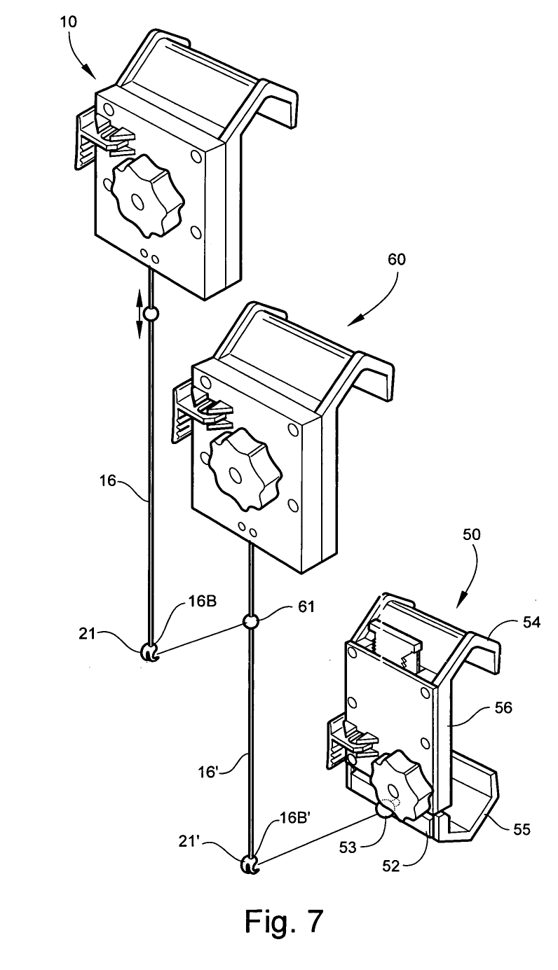

Referring to FIGS. 5 and 6, in another application of the invention, the clamp assembly 10 may be used in combination with a second clamp assembly 50, such as that described in Applicant's U.S. Patent Application (Publication) No. 20050098595 published on May 12, 2005. The complete disclosure of this publication is incorporated by reference herein. The clamp assembly 50 is preferably modified to incorporate a reinforcement channel 52 with a fixed, metal ball fastener 53. The reinforcement channel 52 may be snap-attached, permanently glued, or otherwise mechanically fastened to the clamp assembly 50. As described in the published application, the clamp assembly 50 comprises spaced-apart, generally U-shaped holders 54 and 55 connected to an intermediate gear housing 56 and applicable for engaging a first ladder and a vehicle ladder rack, respectively (neither shown). Hand knob 57 actuates an internal gear rack and pinion to move the clamp assembly 50 into a fixed and locked condition, thereby securing the first ladder to the vehicle rack. The present clamp assembly 10 is then positioned on a second ladder stacked upon the first. The claw fastener 21 at the free end 16B of the flexible cable 16 is applied to the fixed ball fastener 53, as shown in FIG. 6, and the cable 16 retracted, as described above, to secure and lock the second ladder to the underlying first ladder mounted to the vehicle rack.

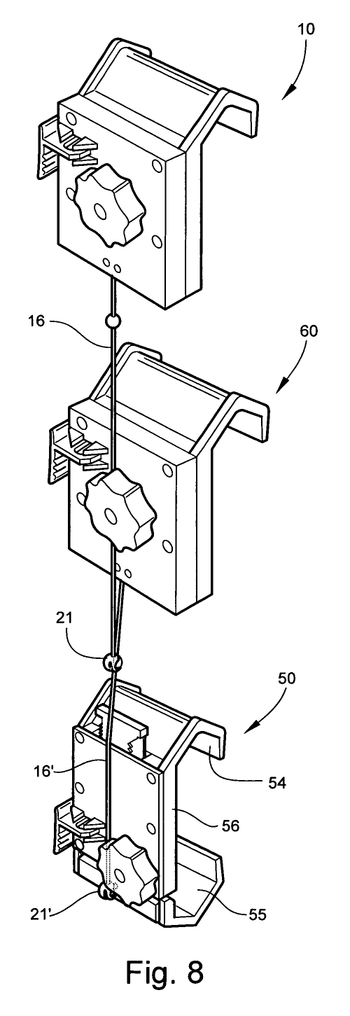

In yet another application, the clamp assembly 10 may be used in combination with two other assemblies 50 and 60, as demonstrated in FIGS. 7 and 8, to secure three stacked ladders (not shown) to a vehicle rack. As indicated above, the bottom clamp assembly 50 comprises spaced-apart, generally U-shaped holders 54, 55 connected to a gear housing 56 and applicable for securing and locking the first ladder to the vehicle ladder rack. The intermediate clamp assembly 60 is identical to the clamp assembly 10 previously described except that ball fastener 61 is permanently fixed to the flexible cable. The operation of clamp assembly 60 is otherwise identical to the clamp assembly 10. Elements common to both clamps 10, 60 and discussed below are indicated in prime notation in FIGS. 7 and 8. The clamp assembly 60 is positioned on the second ladder stacked upon the first, and the claw fastener 21′ at the free end 16B′ of the flexible cable 16′ applied to the fixed ball fastener 53 of the reinforcement channel 52, as shown in FIG. 8. As the cable 16′ is retracted, the clamp assemblies 50 and 60 cooperate to secure and lock the second ladder to the underlying first ladder mounted to the vehicle rack. The third ladder is then stacked upon the second ladder, and the clamp assembly 10 positioned as described above. The claw fastener 21 at the free end 16B of the flexible cable 16 is applied to the fixed ball fastener 61 of the clamp assembly 60, as shown in FIG. 8, and the cable 16 of the clamp assembly 10 retracted to secure and lock the third ladder to the underlying second ladder. Additional clamp assemblies (not shown) may be used to secure four or more stacked ladders to the vehicle rack in a similar manner.

For increased holding strength, the length of the holder in each of the clamp assemblies 10, 50, and 60, described above, is substantially greater that its width, and is preferably equal to or greater than 2 times its width. According to one embodiment, the length of the holder is approximately 3 inches and the width approximately 1.5 inches. The major components of the clamp assembly 10 are preferably formed of a lightweight, durable plastic, such as ABS, PVC, or a polycarbonate, such as Lexan®.

A clamp assembly and method for securing one or more ladders to a vehicle rack are described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

We claim:

1. A clamp assembly for holding first and second articles together, said clamp assembly comprising:
an article holder adapted for engaging the first article;
a flexible cable having a proximal end fixed to said article holder and a free end depending from said article holder;
a first fastener located on said cable between its proximal and free ends;
a second fastener located at the free end of said cable;
means for retracting said cable relative to said article holder; and
whereby the first and second articles are held together by wrapping said cable around the second article, attaching said second fastener to said first fastener, and retracting said cable.

2. A clamp assembly according to claim 1, and comprising a gear housing formed with said article holder.

3. A clamp assembly according to claim 2, wherein said cable retracting means comprises a toothed gear wheel contained within said gear housing, and comprising a plurality of circumferentially-spaced gear teeth.

4. A clamp assembly according to claim 3, and comprising a gear lock adapted for engaging the gear teeth of said gear wheel to hold said gear wheel in a locked condition.

5. A clamp assembly according to claim 4, wherein said gear lock comprises a plurality of locking teeth adapted for meshing with the gear teeth of said gear wheel in the locked condition.

6. A clamp assembly according to claim 5, and comprising biasing means for normally urging said gear lock into the locked condition.

7. A clamp assembly according to claim 6, wherein said biasing means comprises at least one spring.

8. A clamp assembly according to claim 7, and comprising a release arm formed with said gear lock and adapted for being moved against the biasing force of said spring to release said gear lock from the locked condition, such that said cable is extendable from said article holder.

9. A clamp assembly according to claim 3, and comprising an annular, cable-collection shoulder located adjacent said toothed gearwheel and adapted for storing cable retracted within said gear housing.

10. A clamp assembly according to claim 9, wherein said toothed gearwheel comprises an annular, reduced-diameter spacer located adjacent said cable-collection shoulder.

11. A clamp assembly according to claim 10, and comprising a toothed cavity formed with said spacer, and adapted for receiving the proximal end of said cable to secure said cable to said article holder.

12. A clamp assembly according to claim 3, and comprising a hand knob adapted for rotating said toothed gear wheel.

13. A clamp assembly according to claim 1, wherein said article holder comprises a generally U-shaped channel.

14. A clamp assembly according to claim 1, wherein said article holder has a length dimension greater than two times its width dimension.

15. A clamp assembly according to claim 1, wherein said first fastener comprises a ball carried on said cable.

16. A clamp assembly according to claim 15, wherein said second fastener comprises a claw adapted for releasably engaging said ball.

17. A clamping system for holding first and second articles together, said clamping system comprising:
a first clamp assembly comprising:
an article holder adapted for engaging the first article;
a flexible cable having a proximal end fixed to said article holder, and a free end depending from said article holder;
a fastener located at the free end of said cable; and
means for retracting said cable relative to said article holder; and
a second clamp assembly spaced-apart from said first clamp assembly, and comprising an article holder adapted for engaging the second article, said second clamp assembly having a complementary fastener for attaching to the fastener of said first clamp assembly, whereby the first and second clamp assemblies cooperate upon retraction of said cable to hold the first and second articles together.

18. A clamp assembly according to claim 17, wherein said cable retracting means of said first clamp assembly comprises a cable-retraction wheel.

19. A clamp assembly according to claim 18, and comprising a hand knob adapted for rotating said cable-retraction wheel to retract said cable relative to said article holder of said first clamp assembly.

20. A clamp assembly according to claim 17, wherein the article holders of each of said first and second clamp assemblies comprise generally U-shaped channels each having a length dimension at least two times its width dimension.
